(19) United States
(12) Patent Application Publication
(10) Pub. No.: US 2011/0047417 A1
(43) Pub. Date: Feb. 24, 2011

(54) METHOD AND SYSTEM FOR ERROR DETECTION IN PATTERN DEFINITIONS

(76) Inventors: James R. Malnati, Stillwater, MN (US); Donald J. Ethen, New Brighton, MN (US)

Correspondence Address: UNISYS CORPORATION;Office of the General Counsel, 801 Lakeview Drive, Suite 100, MailStop: 2NW, BLUE BELL, PA, 19422, US

(21) Appl. No.: 12/543,081

(22) Filed: Aug. 18, 2009

(51) Int. Cl. G06F 11/00

(52) U.S. Cl. 714/49; 714/57; 714/E11.002

(57) ABSTRACT

A method and system for detecting errors in stored pattern definitions. The method describes structuring a pattern definition into a specified format and creating a pattern definition file. The structured pattern definition contents are hashed to generate a filename for the pattern definition file. This filename, along with a corresponding identifier, is added to an identifier document. Each filename in the identifier document is compared with all other filenames to determine a degree of overlap. A potential error is indicated if a filename substantially matches any of the other filenames in the identifier document.

### TECHNICAL FIELD

The present disclosure relates to automation systems, and more particularly to inspection tools employed for managing databases storing data patterns.

### BACKGROUND

Large-scale computer systems typically incorporate numerous components supplied by disparate manufacturers. Operators at central points in the systems exercise control, generally by receiving system messages and entering system commands. Because the operator often works though a system console, the system messages are referred to as “console messages.” These components usually require unique, often cryptic, commands, and an operator faces considerable difficulty in dealing with the entirety of commands required to control a complex system.

Autoaction Message Systems (AMS), such as Single Point AMS and CLEARPATH AMS, automate complex system operations by embedding required commands in callable pattern files. Each pattern file, stored in an autoaction database, includes message-matching criteria, coupled with any actions to be automatically executed upon matching a system message. Message-matching criteria identify the important parts of a message as well as constraints, such as message length, that must be satisfied for a pattern match. AMS recognizes a system message by comparing it to the pattern definitions in the active autoaction database, and upon determining a match, automatically executes actions defined in the matched pattern.

Pattern files include pattern definitions that characterize the content and context of console messages (the configuration part), and specify the actions to be performed in the event of message match (the action part). AMS uses delimiters (default or user-specified) to separate a message into portions called tokens and to compare the message tokens with the pattern tokens defined in the autoaction database. The “configuration” part provides a pattern identity in a specific “message group” and “message number”, specifies a target message, and identifies which of the message tokens must be the same to produce a match. Other portions of the configuration part may specify a time of day requirement, a variable value required, or other specifications using a CONSTRAINT command. A “match” occurs when the configuration part conditions are met, including the portions of the message defined in a TOKEN command, the number of tokens, the specifications of the CONSTRAINT command, and any other conditions. The pattern definitions can include several other commands such as PRIORITY, TYPE, DELIMITERS, and so on, which are commonly known in relation to AMS.

Conventionally, AMS databases include multiple pattern definitions, and developers, in general, copy-paste pattern definitions across databases as and when required. In certain situations, however, a pattern definition may be copied in other databases with minor modifications. Further, the process of copy-pasting, with or without modification, results in multiple pattern definitions with the same group name across databases. Inevitably, typographical and other errors creep into the pattern definitions in the course of configuring pattern files.

With the proliferation of programming code, AMS databases become very large, and errors in database content become difficult to identify. Because the pattern definitions affect overall system operations, any error introduced into pattern definition content can compromise critical organizational data and severely affect organizational systems and applications. Furthermore, normal personnel rotation may present a situation in which an AMS database administrator may be unsure whether the automation is performing as expected, especially in a multi-system or multi-host file-sharing environment. The only known solution to this problem is a tedious manual examination of each AMS database to ensure proper functioning of the stored pattern definitions.

It would be highly desirable to have an efficient system and method for automatically detecting errors in stored content, especially those affecting system operations, thereby reducing the labor incurred for ensuring code accuracy while expediting the code review process.

### SUMMARY

One aspect of the present disclosure describes a method for detecting errors in one or more pattern definitions stored in a database storage system. The method includes structuring a pattern definition into a specified format, and creating a corresponding pattern definition file. The pattern definition filename is generated by hashing at least part of the structured pattern definition content, and adding the filename to an identifier document, along with a corresponding identifier. Each pattern definition filename in the identifier document is compared with all other pattern definition filenames. The method indicates a potential error upon determining that a pattern definition filename in the identifier document substantially matches any of the other pattern definition filenames.

A further embodiment of the disclosure relates to a system for error detection comprising a database storage system including at least one pattern definition, and a data processing system operatively coupled to the database storage system. The data processing system further includes means for structuring the pattern definition into a specified format, means for creating a pattern definition file, and means for generating a pattern definition filename by hashing at least part of the structured pattern definition content. The data processing system also includes an identifier document that stores the pattern definition filename with a corresponding identifier. A further means in the data processing system compares each pattern definition filename in the identifier document with all other pattern definition filenames. Finally, the data processing system includes a means for indicating a potential error when a pattern definition filename in the identifier document substantially matches any of the other pattern definition filenames.

### BRIEF DESCRIPTION OF THE DRAWINGS

FIG. 1 depicts an embodiment of a system for detecting errors in stored pattern definitions.

FIG. 2 depicts an embodiment of an identifier document including pattern definition filenames with corresponding identifiers.

FIG. 3 depicts an embodiment of a method for detecting errors in stored pattern definitions.

### DETAILED DESCRIPTION

The following detailed description is made with reference to the figures. Embodiments are described to illustrate the claimed subject matter, not to limit its scope, which is defined solely by the claims appended hereto. Those of ordinary skill in the art will recognize a variety of equivalent variations on the description that follows.

The present disclosure describes a method and system for detecting errors in stored pattern definitions. The pattern definitions can include executable commands, mask values, message tokens, and other identifiers such as the name of a database source file, including the pattern definition. The method begins by formatting the pattern definition in a form suitable for automated processing, and it then creates a corresponding pattern definition file. The pattern definition contents are hashed to generate a filename, which along with a corresponding identifier, is added to an identifier document. Each pattern definition filename in the identifier document is compared with all other pattern definition filenames. Ideally, the filenames hashed from contents of different pattern definitions are unique values, and therefore, any duplication of filenames indicates potentially incorrect configuration of the pattern definitions. The method indicates a potential error upon determining that a pattern definition filename in the identifier document substantially matches any of the other pattern definition filenames, especially if the corresponding identifiers of the two filenames are different.

The present disclosure further describes operations of the claimed system and methods in relation to the Unisys Operations Sentinel Autoaction Message System (AMS). Persons skilled in the art, however, will appreciate that the disclosed embodiments can be employed for error detection in various other systems that store patterns. AMS is available as SP-AMS in the Operations Sentinel environment for Master Control Program (MCP) and UNIX systems and partitions, and as CP-AMS on CLEARPATH systems for automating system operations, all commercially available from Unisys. CLEARPATH systems include a console on which compiled CP-AMS databases are installed.

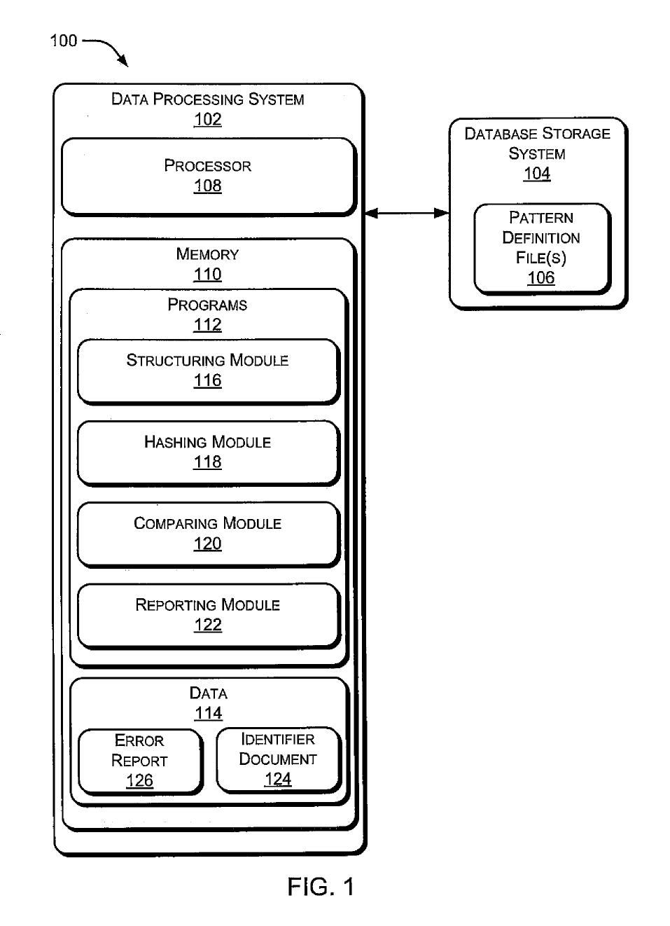

FIG. 1 illustrates an embodiment of the present disclosure describing a system 100 for detecting errors in stored pattern definitions. For clarity, the system 100 is described in relation to an AMS installation. The system 100 comprises a pattern processing system 102, operatively coupled to a database storage system 104, with the storage system further including pattern definitions 106. A typical AMS database will include a large number of pattern definitions, running into the thousands in some systems.

The pattern processing system 102 further includes a processor 108 coupled to a memory 110, which processes the pattern definitions 106. The processor 108 can include one or more microprocessors, microcomputers, microcontrollers, digital signal processors, central processing units, state machines, logic circuitries, or other devices that manipulate signals based on operational instructions. Among its capabilities, the processor 108 fetches and executes computer-readable instructions stored in the memory 110.

The memory 110 can include any computer-readable medium known in the art, including, for example, volatile memory such as a random access memory, or non-volatile memory such as flash memory. As illustrated in FIG. 1, the memory 110 further includes programs 112, and data 114. The programs 112 include modules such as a structuring module 116, a hashing module 118, a comparing module 120, and a reporting module 122 for processing the pattern definitions 106, and detecting errors in the stored patterns. The structuring module 116 performs two functions, namely, formatting the pattern definitions 106 in a form suitable for automated processing, and creating a corresponding pattern definition file. The hashing module 118 hashes the contents of each pattern definition 106 to generate a pattern definition filename. Table 1 and 2 illustrate an exemplary method for generating a filename by hashing pattern definition content. Table 1 depicts an exemplary pattern definition, while Table 2 depicts filename generation.

TABLE 1
Pattern Definition
Pattern Definition

DEFINE “BTCH81-FIN” 1
MESSAGE “BTCH81 FIN hhmm:ss”
/*--1---*-2-*---3--- */
TYPE ANY-SENDER OTHER
INSTANCE PRIMARY
PRIORITY 128
TOKEN FIXED 2 “FIN”
TOKEN MASKED 1 “BTCH8\*1\″

TABLE 2
Method to generate filename
Filename Generation

| | Relevant part from |
|---|---|
| Filename | pattern definition |
| F2 | TOKEN FIXED 2 |
| F2FIN | “FIN” |
| F2FINM1 | TOKEN MASKED 1 |
| F2FINM1BTCH8A21A | ″BTCH8\*1\” |
| F2FINM1BTCH8A21AIP | INSTANCE |
| | PRIMARY |
| F2FINM1BTCH8A21AIPP128 | PRIORITY 128 |
| F2FINM1BTCH8A21AIPP128.003 | MESSAGE “BTCH81 |
| | FIN hhmm:ss” |
| | (3 tokens) |
| F2FINM1BTCH8A21AIPP128.003.CMRAUDIT | name of AMS |
| | database |

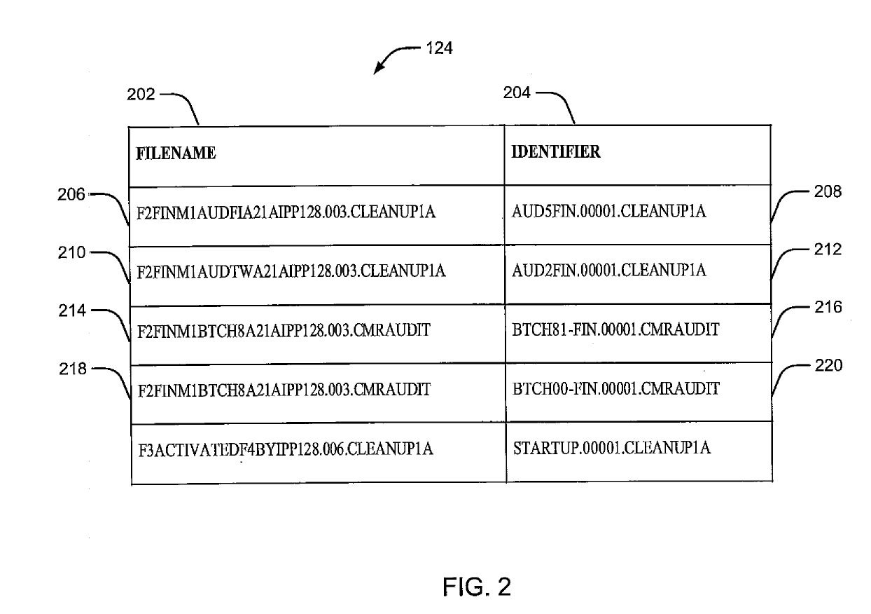

In the present disclosure, non-alphabetic characters are translated into one of the digits 0-9, or one of “A”, “B”, or “C”. Further, in the above example, the character “\” is translated to “A”. The hashed filename for the pattern “BTCH81-FIN” 1, thus, is F2FINM1BTCH8A21AIPP128.003.CMRAUDIT. This filename is associated with a corresponding identifier comprising, the message group name, message number, and the AMS database name that includes the pattern definition. In the previous example, the generated identifier would be BTCH81-FIN.00001.CMRAUDIT. Several other instances of hashed filename and identifier pairs are illustrated in FIG. 2, as discussed below.

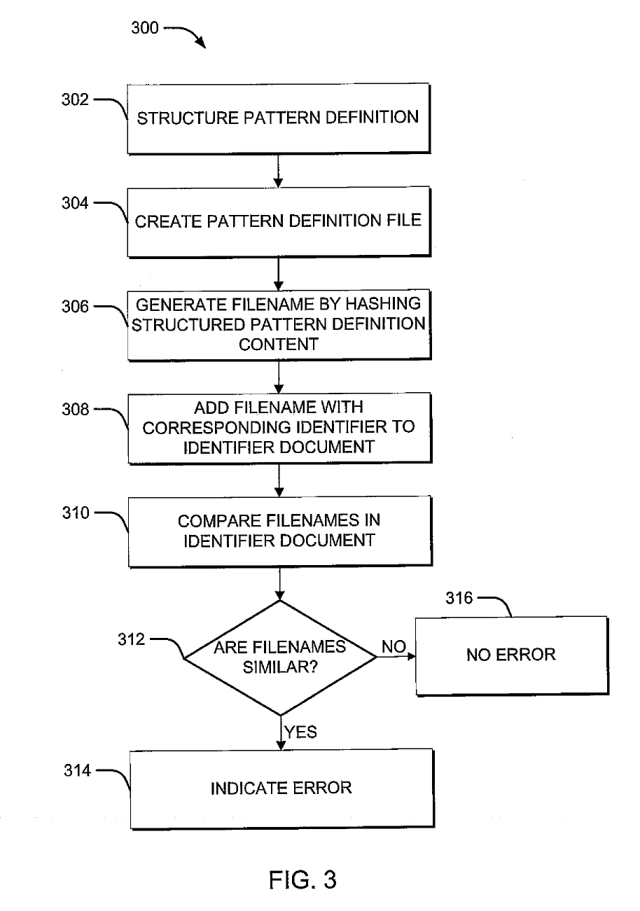

The hashing module 118 further adds the generated pattern definition filename, with the corresponding identifier, to an identifier document 124, which is included in the data 114. The data 114 can further include an error report 126, information stored or employed by the programs 112, or information generated by the execution of any one of the programs 112. For example, the comparing module 120 compares the identifier document 124 contents to determine if a hashed pattern definition filename and its corresponding identifier substantially matches any other pattern definition filename and its corresponding identifier. The reporting module 122 stores the result of this comparison in the error report 126. Alternatively, the reporting module 122 outputs the error report 126 as an audio or visual error message. A more detailed description of the functioning of these modules is provided in relation to the description of FIG. 3, below. Further, those of skill in the art will appreciate that the memory 110 can include several other modules, other than those illustrated in FIG. 1, for supplementing applications on any computing based device such as process receiving applications, update applications, and such.

FIG. 2 illustrates an embodiment of the contents of the identifier document 124, employed for detecting errors in stored pattern definitions. Upon creating a pattern definition file, a log entry including a filename and a corresponding identifier, as illustrated in FIG. 2, is written to the identifier document 124. The filename is generated by hashing the pattern definition contents, where as the identifier includes parameters such as the pattern definition name, and names of one or more database source files that include the pattern definition.

FIG. 2 illustrates exemplary log entries 206-220 added to the identifier document 124, corresponding to various created pattern definition files. The log entries identify the location of the pattern definitions for subsequent comparison. The first log entry including a filename 206 associated with a corresponding identifier 208, for example, indicates that an AMS pattern definition “AUD5FIN 00001”, found in AMS database source file CLEANUP1A.BLD, is in file 206, with filename F2FINM1AUDFIA21AIPP128.003.CLEANUP1A. Similarly, the second illustrated log entry, including a filename 210 and a corresponding identifier 212, indicates that an AMS database pattern “AUD2FIN 00001”, found in AMS database source file CLEANUP1A.BLD, is in file F2FINM1AUDTWA21AIPP128.003.CLEANUP1A. The third illustrated log entry 216 includes a filename 214 and a corresponding identifier 216; it relates to the exemplary pattern definition “BTCH81-FIN 00001”, included in the previous section describing the functioning of the hashing module 118 of FIG. 1. Similarly, the fourth illustrated entry includes a filename 218 and a corresponding identifier 220, relating to a pattern definition “BTCH00-FIN”, stored in the CMRAUDIT AMS database, which is configured as depicted in table 3.

TABLE 3
Exemplary Pattern Definition
Pattern Definition

DEFINE “BTCH00-FIN” 1
MESSAGE “BTCH00 FIN hhmm:ss”
/* --1---*-2-*---3--- */
TYPE ANY-SENDER OTHER
INSTANCE PRIMARY
PRIORITY 128
TOKEN FIXED 2 “FIN”
TOKEN MASKED 1 “BTCH8\*1\″

Table 4 sets out the steps for generating the filename by hashing the contents of this pattern definition:

TABLE 4
Method for Generating Filename
Filename Generation

| | |
|---|---|
| F2 | TOKEN FIXED 2 |
| F2FIN | “FIN” |
| F2FINM1 | TOKEN MASKED 1 |
| F2FINM1BTCH8A21A | “BTCH8\*1\” |
| F2FINM1BTCH8A21AIP | INSTANCE |
| | PRIMARY |
| F2FINM1BTCH8A21AIPP128 | PRIORITY 128 |
| F2FINM1BTCH8A21AIPP128.003 | MESSAGE “BTCH81 |
| | FIN hhmm:ss” |
| | (3 tokens) |
| F2FINM1BTCH8A21AIPP128.003.CMRAUDIT | (name of AMS |
| | database) |

The configuration of the pattern definition “BTCH00-FIN” (depicted in Table 3) indicates an error in TOKEN 1 masking, owing to an erroneous copy- and paste operation. The error produces identical filenames for the patterns, “BTCH81-FIN” and “BTCH00-FIN”, even though the patterns have different identifiers. Identical identifiers 216 and 220 for identical filenames would indicate identical patterns, and no potential errors. Here, the two patterns have different identifiers 216 and 220, but the filenames 214 and 218 are identical, which indicates that a potential pattern configuration error may have occurred. Generally, identical entries in the identifier document 124 indicate potentially incorrect configuration of the pattern definition contents such as database commands, tokens, message group name, message number, or a database source filename. Thus, a user such as a developer or a database administrator can easily view and rectify the discovered errors without manually inspecting huge volumes of data patterns in multiple databases.

FIG. 3, a flow diagram, illustrates an embodiment 300 of the disclosed method for detecting errors in stored pattern definitions. This method rapidly ensures that no typographical errors, such as, cut-and-paste errors, occur within identically constructed pattern definitions. The method operates with one or more shell scripts for creating unique identification for each pattern definition and detecting potential errors in stored patterns automatically. The method thus enables better management of pattern definitions in AMS databases.

As was done with FIG. 1, FIG. 3 is set within the environment of an AMS installation. Here, the AMS configuration includes one or more autoaction databases, an Autoaction Database Manager (ADBM) to develop and maintain autoaction databases, and command prompt utilities, such as, Build Autoaction Database (BADB), Dump Autoaction Database (DADB), Verify Autoaction Database (VADB), and Distribute, to create, update, dump, test, and distribute autoaction databases. The autoaction databases store a series of patterns, which include message-matching criteria employed for matching messages from managed systems. Further, the autoaction databases automatically execute actions when the pattern matches a system message. AMS recognizes a system message by comparing it to the patterns defined in the active autoaction database. AMS uses either default or user-specified delimiters, such as, spaces, to separate a message into parts called tokens, and then compare the message tokens to the pattern tokens defined in the autoaction database. A match occurs when all the tokens defined in a pattern match tokens of the system message, and all constraints defined in the pattern are satisfied.

AMS databases include one or more source files compiled into a single database. To ensure accurate configuration of stored pattern definitions, step 302 describes structuring each pattern definition in a format suitable for programmatic scanning. To this end, pattern definitions in one or more database source files or compiled databases are structured into DADB formatted source files. The DADB utility employs a run-time autoaction database as input, and produces a corresponding source file.

Subdirectories created in AMS database source files, such as CLEANUP2.BLD, CMRAUDIT.BLD, CMRBUDGT.BLD, CMRDAILY.BLD, and CMRMONTH.BLD, store these pattern definitions. A subdirectory name stores a specified pattern, and it includes at least part of the names of one or more AMS database source files that in turn include the specified pattern definition. For example, the subdirectory name _CLEANUP2_CMRAUDIT_CMRBUDGT_CMRMONTH_stores pattern definitions found in several AMS database source files.

At step 304, the disclosed method creates a pattern definition file for the specified pattern. The pattern definition file is stored in the subdirectory, the name of which includes at least part of the names of the AMS database source files that include the specified pattern definition. Step 306 describes generation of the pattern definition filename by hashing one or more configurative database commands, such as, TOKEN, TYPE, and INSTANCE, number of tokens in a “MESSAGE” command, and the AMS database source filename including the specified pattern definition. The filename can also comprise token types, positions, text, instance, priority, token count, and variable-length. An exemplary hashing process for generating a pattern definition filename for the pattern “BTCH81-FIN” is described in relation to the description of FIG. 1 in the previous section.

Subsequently, each generated filename is paired with an identifier presenting a message group name and message number, which identifies the pattern definition. Step 308 adds the filename with the corresponding identifier to an identifier document upon creation of the corresponding pattern definition file. Each entry in the identifier file, thus, serves as a log of the file creation process. The entry further provides the name of the AMS database, including the specified pattern definition. FIG. 2 illustrates a few further examples of identifier document entries.

Step 310 relates to inspection of the identifier document contents for detecting potential errors in stored pattern definitions based on the filename and identifier pair included in the identifier document. Each entry in the identifier document is compared to all other entries to determine a degree of overlap. In an alternative embodiment of the present disclosure, the identifier document contents are sorted in a specified order, and each entry of the identifier is compared to a subsequent entry to determine the degree of overlap between the filenames and their corresponding identifiers.

Ideally, the filenames hashed from contents of different pattern definitions are unique values, and therefore, any duplication of filenames indicates a potentially incorrect configuration of the pattern definitions, especially if the corresponding identifiers associated with the matching filenames are different. Thus, if the filenames are found to be similar at step 312, a potential error is indicated at step 314. In case the filenames are not similar at step 316, no error is indicated. Matching log entries in the identifier document indicate identically configured patterns definitions, even when including different message groups or message numbers, or AMS database name. Unless this situation is corrected, a system message may not match the correct pattern, thus hindering the intended, and often critical, system and business operations. The potential error indication allows a user such as a developer or a database administrator to rectify the code, ensuring expected code operation among identically defined pattern definitions in multiple databases.

The disclosed system and method uniquely identify pattern and variable definitions among the thousands of pattern definitions in storage databases for comparative and analytical purposes. The unique identification and comparison reveal potential coding or data configuration errors before they are implemented in actual systems. The potential errors, outputted in an audio or a visual report form, clearly delineate the patterns whose filenames register a match, thus, expediting the code review process. Implementation of the disclosed method or system not only reduces days of manual inspection effort, but also instances of product re-work, wastage, or recalls. This responsibility shift has the tendency to enhance in-person manual inspections by focusing on more high-level aspects of development, such as design and long-term maintenance issues.

The specification has described a method and system for detecting errors in stored pattern definitions. The specification has set out a number of specific exemplary embodiments, but persons of skill in the art will understand that variations in these embodiments will naturally occur in the course of embodying the claimed invention in specific implementations and environments. Certain features that are described in this specification in the context of separate embodiments can also be implemented in combination in a single embodiment. Conversely, various features that are described in the context of a single embodiment can also be implemented in multiple embodiments separately or in any suitable sub-combination.

It will be appreciated that several of the features and functions disclosed above, or alternatives thereof, may be desirably combined into many other different systems or applications. It will further be understood that such variations, and others as well, fall within the scope of the claimed invention. Neither those possible variations nor the specific examples set above are set out to limit the scope of the claimed invention. Rather, the scope of claimed invention is defined solely by the claims set out below.

We claim:

1) A method for error detection comprising:
structuring a pattern definition stored in a database storage system into a specified format;
creating a pattern definition file;
hashing at least part of the structured pattern definition content to generate a pattern definition filename;
adding the pattern definition filename with a corresponding identifier to an identifier document;
comparing each pattern definition filename in the identifier document with all other pattern definition filenames in the identifier document, and
indicating a potential error upon determining that a pattern definition filename in the identifier document substantially matches any of the other pattern definition filenames in the identifier document.

2) The method of claim 1, wherein the pattern definition content includes:
one or more database commands included in the structured pattern definition,
number of tokens in a message command, and
name of a database source file including the pattern definition.

3) The method of claim 1, wherein the database storage system includes an Autoaction Message System (AMS).

4) The method of claim 3, wherein the structuring step uses a Dump AMS database (DADB) utility to structure the pattern definition into the specified format.

5) The method of claim 1, wherein the indicating includes generating at least one of an audio, or visual error message.

6) The method of claim 1, wherein the potential error is triggered upon a determination of pattern definition filenames of two different pattern definitions being substantially identical excepting the corresponding identifier.

7) The method of claim 1, wherein the identifier includes one or more of:
a message group-name,
a message number identifying the pattern definition, or
name of a database source file including the pattern definition.

8) The method of claim 1 further comprising a step of storing the pattern definition file in a directory, the directory name being derived at least in part from the name of a database source file including the pattern definition.

9) A system for error detection comprising:
a database storage system including at least one pattern definition;
a data processing system operatively coupled to the database storage system, the data processing system including:
means for structuring the pattern definition stored in the database storage system into a specified format;
means for creating a pattern definition file;
means for hashing at least part of the structured pattern definition content to generate a pattern definition filename;
an identifier document including the pattern definition filename with a corresponding identifier;
means for comparing each pattern definition filename in the identifier document with all other pattern definition filenames in the identifier document, and
means for indicating a potential error when a pattern definition filename in the identifier document substantially matches any of the other pattern definition filenames in the identifier document.

10) The system of claim 9, wherein the means for hashing generates the pattern definition filename by hashing:
one or more of a database command included in the structured pattern definition,
number of tokens in a “message” command, and
name of a database source file including the pattern definition.

11) The method of claim 9, wherein the database storage system includes an Autoaction Message System (AMS).

12) The method of claim 11, wherein the means for structuring formats the pattern definition into a format suitable is a Dump AMS database (DADB) utility.

13) The method of claim 9, wherein the means for indicating further includes means for generating at least one of an audio, or visual error message.

14) The method of claim 9, wherein the identifier includes one or more of:
a message group-name,
message number identifying the pattern definition, or
name of the database storing the pattern definition.

15) The method of claim 9, wherein the data storage system further comprises a directory for storing the pattern definition file, the directory name being derived at least in part from the name of a database source file including the pattern definition.

16) A method for error detection in Autoaction Message System (AMS) database pattern definitions comprising:
structuring a pattern definition stored in the AMS database into a specified format;
creating a pattern definition file;
generating a pattern definition filename by hashing at least part of the structured pattern definition content including one or more AMS database commands included in the structured pattern definition, number of tokens in a message command, and the name of a database source file including the pattern definition;
adding the pattern definition filename with a corresponding identifier to an identifier document;
comparing each pattern definition filename in the identifier document with a subsequent pattern definition filename in the identifier document, and
indicating a potential error when a pattern definition filename in the identifier document substantially matches a subsequent pattern definition filename in the identifier document.
